(19) United States
(12) Patent Application Publication
(10) Pub. No.: US 2020/0391784 A1
(43) Pub. Date: Dec. 17, 2020

(54) STOPPER DEVICE FOR VEHICLE AND STEERING DEVICE FOR VEHICLE USING SAME

(71) Applicant: SHOWA CORPORATION, Gyoda-shi, Saitama (JP)

(72) Inventors: Tatsuya Saito, Haga-gun, Tochigi (JP); Yusuke Anma, Haga-gun, Tochigi (JP); Takafumi Ojio, Haga-gun, Tochigi (JP)

(21) Appl. No.: 16/977,661

(22) PCT Filed: Apr. 26, 2018
(86) PCT No.: PCT/JP2018/016982

§ 371 Date: Sep. 2, 2020

(51) Int. Cl. B62D 5/00; B62D 1/04; F16D 63/00; F16D 65/16

(52) U.S. Cl. CPC B62D 5/001; B62D 1/04; B62D 5/04; F16D 65/16; F16D 63/006

(57) ABSTRACT

A stopper device for vehicle includes a movable member, a swing lever capable of swinging in the direction in which the movable member is locked, a solenoid coupled to the swing lever, and a pushing member that pushes the swing lever in the unlocking direction relative to the movable member. The solenoid includes a plunger coupled to the swing lever, and a magnetizing coil to drive the plunger.

### TECHNICAL FIELD

The present disclosure relates to improvement technologies with regard to a stopper device for vehicle and to a steering device for vehicle using the same.

### BACKGROUND ART

Various kinds of stopper devices are provided on a vehicle. For example, there is a steering device for vehicle that has a mechanism (a stopper device for vehicle) which is capable of restricting a turnable range and which is built in a steering unit at which turning of a steering wheel is input. This kind of steering device for vehicle is disclosed in, for example, Patent Document 1.

The steering device for vehicle disclosed in Patent Document 1 is a so-called steer-by-wire steering device which has a steering unit at which turning of a steering wheel is input, and a turning unit that turns turning wheels, those units being mechanically separated from each other. This steering device for vehicle includes an operative position restricting device (a stopper device for vehicle) capable of changing the turnable range of the steering wheel as appropriate in accordance with, for example, a running state of a vehicle and a state of the steering unit.

This operative position restricting device includes a locking wheel in a gear shape, a swing lever capable of latching with the locking wheel, and a plunger device that actuates this swing lever. The plunger of the plunger device is coupled to one end portion of the swing lever. The locking wheel is rotatable corresponding to a turning of the steering wheel, and includes plurality of teeth on the outer circumference surface. The swing lever has a tip portion capable of latching and unlatching with the tooth of the locking wheel, and is actuated by the plunger device so as to swing.

A driver's operation to turn the steering wheel in a direction in which the steering angle increases will be referred to as a “turn increasing operation”. A driver's operation to turn the steering wheel in a direction in which the steering angle decreases (a neutral direction) after the turn increasing operation will be referred to as a “turn returning operation”.

When the turn increasing operation is given to the steering wheel, the locking wheel rotates in the same direction. When the turn increasing operation to the steering wheel is given up to the limit of the turnable range, the plunger device locks the swing lever.

### CITATION LIST

### Patent Literatures

Patent Document 1: Japan Patent No. 4193576

### SUMMARY OF INVENTION

### Technical Problem

Even if a temporal malfunction occurs, it is preferable that the stopper device for vehicle utilized in a steering device for vehicle should maintain a function.

An objective of the present disclosure is to provide a stopper device for vehicle capable of maintaining a suitable operation as much as possible regardless of a situation.

### Solution to Problem

A steering device for vehicle according to the present disclosure includes:

a movable member;

a swing lever capable of swinging in a direction in which the movable member is locked;

a solenoid that includes a plunger coupled to the swing lever, and a magnetizing coil to drive the plunger; and

a pushing member that pushes the swing lever in an unlocking direction relative to the movable member.

### Advantageous Effects of Invention

According to the present disclosure,

the swing lever capable of swinging in the direction in which the movable member is locked is coupled to the plunger of the solenoid. Moreover, the swing lever is pushed by the pushing member in the unlocking direction. Accordingly, when the magnetizing coil is not magnetized, even if the swing lever is still in the locked state relative to the movable member, the pushing member surely causes the swing lever to swing in the unlocking direction. When the magnetizing coil is in an un-magnetized state, the movable member can be in an original movable state. That is, the stopper device for vehicle can maintain the functions even if a temporal malfunction occurs.

### BRIEF DESCRIPTION OF DRAWINGS

FIG. 1 is an exemplarily diagram illustrating a steering device for vehicle using a stopper device for vehicle according to a first embodiment of the present disclosure;

FIG. 2 is a cross-sectional view illustrating the stopper device for vehicle illustrated in FIG. 1;

FIGS. 3A to 3C are a cross-sectional view and relevant views of a solenoid illustrated in FIG. 2;

FIG. 4 is a perspective view of a position detecting unit illustrated in FIG. 3;

FIG. 5 is a control-circuit diagram for the solenoid by a control unit illustrated in FIG. 1;

FIG. 6 is cross-sectional view of a stopper device for vehicle of a steering device for vehicle according to a second embodiment of the present disclosure;

FIG. 7 is a cross-sectional view of a stopper device for vehicle of a steering device for vehicle according to a third embodiment of the present disclosure; and

FIGS. 8A and 8B are each a cross-sectional view illustrating a cross-section taken along an arrow line 8a-8a in FIG. 7, and a cross-section taken along a line 8b-8b therein.

### DESCRIPTION OF EMBODIMENTS

Embodiments of the present disclosure will be described below with reference to the accompanying figures.

### First Embodiment

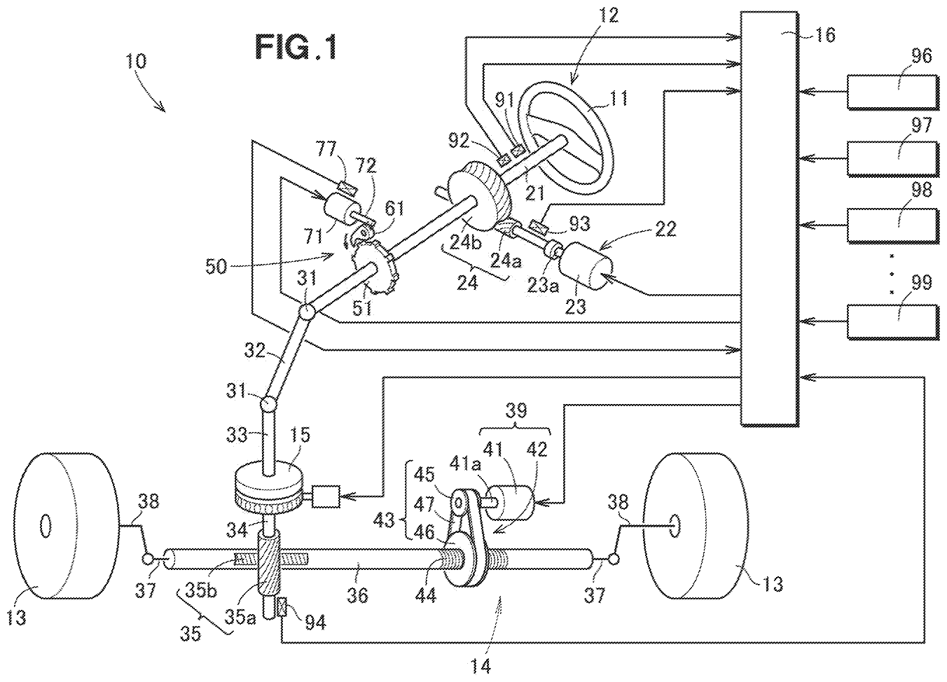

A steering device 10 for vehicle that utilizes a stopper device 50 for vehicle according to a first embodiment will be described with reference to FIG. 1 to FIG. 5.

As illustrated in FIG. 1, the steering device 10 for vehicle includes a steering unit 12 at which a turning operation of a steering wheel 11 of a vehicle is input, a turning unit 14 that turns right and left turning wheels 13, 13, a clutch 15 present between the steering unit 12 and the turning unit 14, and a control unit 16. In a normal state in which the clutch 15 is disengaged, the steering unit 12 and the turning unit 14 are mechanically separated from each other. Thus, the steering device 10 for vehicle adopts a so-called steer-by-wire (SBW) scheme of turning the right and left turning wheels 13 and 13 by actuating a turning actuator 39 in accordance with a turned amount of the steering wheel 11.

The steering unit 12 includes the steering wheel 11 to be operated by a driver, a steering shaft 21 coupled to the steering wheel 11, and a reactive force applying actuator 22 that adds steering reactive force (reactive force torque) to the steering wheel 11. The reactive force applying actuator 22 gives a steering feeling to the driver by generating steering reactive force against steering force to the steering wheel 11 by the driver. The reactive force actuator 22 will be referred to as a “first actuator 22” as appropriate below.

The reactive force applying actuator 22 includes a reactive force motor 23 (a first motor 23) that generates the steering reactive force, and a reactive force transmission mechanism 24 that transmits the steering reactive force to the steering shaft 21. The reactive force motor 23 is, for example, an electric motor. The reactive force transmission mechanism 24 is, for example, a worm-gear mechanism. This worm-gear mechanism 24 (the reactive force transmission mechanism 24) includes a worm 24a provided on a motor shaft 23a of the reactive force motor 23, and a worm wheel 24b provided on the steering shaft 21. The steering reactive force generated by the reactive force motor 23 is applied to the steering shaft 21 through the reactive force transmission mechanism 24.

The turning unit 14 includes an input shaft 33 coupled to the steering shaft 21 through shaft universal joints 31 and 31 and a coupling shaft 32, an output shaft 34 coupled to the input shaft 33 through the clutch 15, a turning shaft 36 coupled to the output shaft 34 by an operative force transmission mechanism 35, the right and left turning wheels 13 and 13 connected to both ends of the turning shaft 36, respectively, through respective tie rods 37 and 37 and respective king pins 38 and 38, and a turning actuator 39 that applies turning force to the turning shaft 36. The turning actuator 39 will be referred to as a “second actuator 39” as appropriate below.

The operative force transmission mechanism 35 is, for example, a rack-and-pinion mechanism. The rack-and-pinion mechanism 35 (the operative force transmission mechanism 35) includes a pinion 35a provided on the output shaft 34, and a rack 35b provided on the turning shaft 36. The turning shaft 36 is movable in the axial direction (a vehicle widthwise direction).

The turning actuator 39 includes a turning power motor 41 (a second motor 41) that generates power for turning, and a turning power transmission mechanism 42 that transmits the turning power to the turning shaft 36. The turning power generated by the turning power motor 41 is transmitted to the turning shaft 36 by the turning power transmission mechanism 42. Consequently, the turning shaft 36 slides in the vehicle widthwise direction. The turning power motor 41 is, for example, an electric motor.

The turning power transmission mechanism 42 includes, for example, a belt drive mechanism 43 and a ball screw 44. The belt drive mechanism 43 includes a drive pulley 45 provided at a motor shaft 41a of the turning power motor 41, a follower pulley 46 provided on the nut of the ball screw 44, and a belt 47 tensioned between the drive pulley 45 and the follower pulley 46. The ball screw 44 is a kind of a conversion mechanism that converts rotary motion to linear motion, and transmits drive force generated by the turning power motor 41 to the turning shaft 36. Note that the turning power transmission mechanism 42 is not limited to a structure of the belt drive mechanism 43 and of the ball screw 44, and may be, for example, a worm-gear mechanism or a rack-and-pinion mechanism.

The steering device 10 for vehicle according to the present disclosure includes the stopper device 50 for vehicle. The stopper device 50 for vehicle is utilized as an “operative position restricting device” capable of restricting the turnable range of the steering wheel 11. That is, the stopper device 50 for vehicle plays a role as a stopper to restrict the turnable range of the steering wheel 11. The stopper device 50 for vehicle will be also referred to as an “operative position restricting device 50” as appropriate below. The operative position restricting device 50 is present between the reactive force applying actuator 22 in the steering unit 12 and the clutch 15.

The operative position restricting device 50 will be described in detail. The operative position restricting device 50 is capable of changing the turnable range of the steering wheel 11 as appropriate in accordance with the running state of the vehicle and/or the state of the steering device. For example, when the load to the turning unit 14 becomes equal to or greater than a predetermined quantity (overload) that is set in advance, and/or when the turning unit 14 is in an overloaded state and the position of the turning shaft 36 is equal to or greater than a prescribed value, the operative position restricting device 50 restricts the turnable range of the steering wheel 11.

This overload may occur in, for example, the following situation. First, when the turning wheel 13 is hitting an obstacle like an edge stone, the load to the turning unit 14 increases. Second, when the turning shaft 36 moves up to the limit (a rack end) in the movable axial direction, the load to the turning unit 14 increases. Under such a situation, if the turn increasing operation to the steering wheel 11 is kept, a large load is to be applied to the clutch 15 and to the reactive force applying actuator 22. At this time, the operative position restricting device 50 that receives a control signal from the control unit 16 restricts the turnable range so as to suppress the increasing operation to the steering wheel 11. Regardless of such a situation, when the load increases, a restriction is made. Consequently, no large load is applied to the clutch 15 and to the reactive force applying actuator 22. This enables downsizing of the clutch 15 and of the reactive force applying actuator 22.

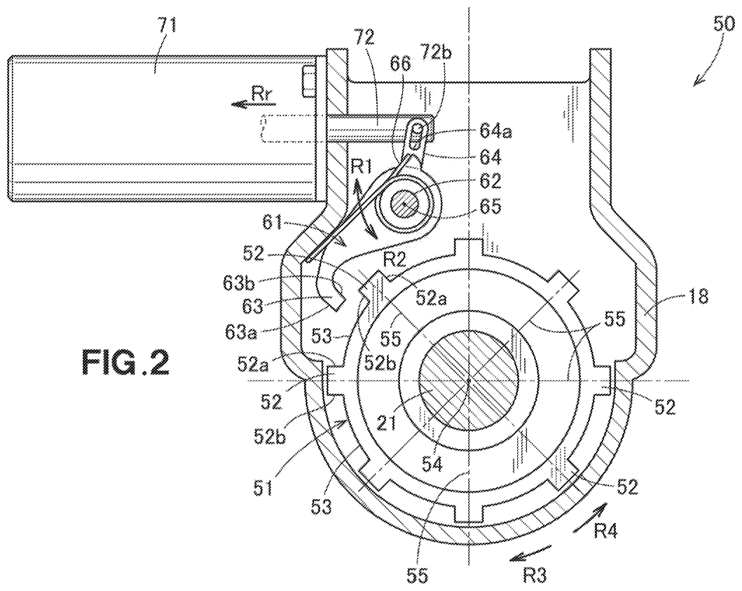

As illustrated in FIG. 2, the operative position restricting device 50 includes a single movable member 51 (a latched member 51), a single swing lever 61 (a latching member 61) corresponding to the single movable member 51, a single pushing member 66, and a single solenoid 71. The movable member 51, the swing lever 61, the pushing member 66, and the solenoid 71 are retained in a housing 18.

The movable member 51 is rotatable together with the steering wheel 11 illustrated in FIG. 1, and is attached to, for example, the steering shaft 21. That is, the movable member 51 is a member in a disk shape rotatable together with the steering shaft 21. This movable member 51 is a locking wheel (a locking gear) in a disk shape with a plurality of teeth 52. The plurality of teeth 52 is arranged in a rotational direction at a constant pitch on the outer circumference surface of the movable member 51 or the disk-edge surface thereof. The movable member 51 will be also referred to as a “locking wheel 51” as appropriate below.

The plurality of teeth 52 is extended in the radial direction from, for example, the outer circumference surface of the locking wheel 51 in the disk shape. When viewed along a rotational center line 54 of the locking wheel 51 (a center axis 54 of the steering shaft 21), the shape of the plurality of teeth 52 is a bilaterally symmetrical rectangular shape relative to each straight line 55 which intersects the rotational center line 54 and which is extended in the radial direction.

The swing lever 61 is capable of restricting the rotational range of the locking wheel 51, i.e., swinging the locking wheel 51 in the locking direction by being latched with the locking wheel 51 (the movable member 51).

The swing lever 61 is a member in a substantially bar shape having a center part supported by the housing 18 through a support shaft 62 so as to be swingable. This swing lever 61 has a stopper part 63 at one end (a first end), and has a driven lever 64 at another end (a second end). A swing center 65 of the swing lever 61 is the axial center of the support shaft 64. The swing center 65 will be also referred to as the “axial center 65 of the support shaft 64” as appropriate below.

The stopper part 63 is a hook-shape part to be latched with each tooth 52 of the locking wheel 51, and can be positioned at each of a plurality of tooth grooves 53 (a space between the adjoining teeth 52 and 52). The stopper part 63 includes a first latching surface 63a and a second latching surface 63b. The second latching surface 63b is located near the swing center 65 of a first swing lever 161A relative to the first latching surface 63a.

The pushing member 66 applies force so as to push the swing lever 61 in an unlocking direction R1 relative to the locking wheel 51, and is, for example, a “torsion coil spring”. More specifically, the swing lever 61 is pushed by the pushing member 66 in the unlocking direction R1 (an unlatching direction R1) in which the stopper part 63 is unlatched with each of the plurality of teeth 52 of the locking wheel 51. Note that the pushing member 66 is not limited to a torsion coil spring, and may be, for example, a compression coil spring. The pushing member 66 will be also referred to as a “first pushing member 66” as appropriate below.

As described above, the first pushing member 66 pushes the swing lever 61 in the unlocking direction R1 relative to the locking wheel 51. Hence, even if the support shaft 64 is damaged or the support shaft 64 is detached from the pin 72b, the swing lever 61 does not lock the locking wheel 51.

The driven lever 64 is driven by the solenoid 71 so as to swing. The solenoid 71 is an electromagnetic solenoid attached to the housing 18.

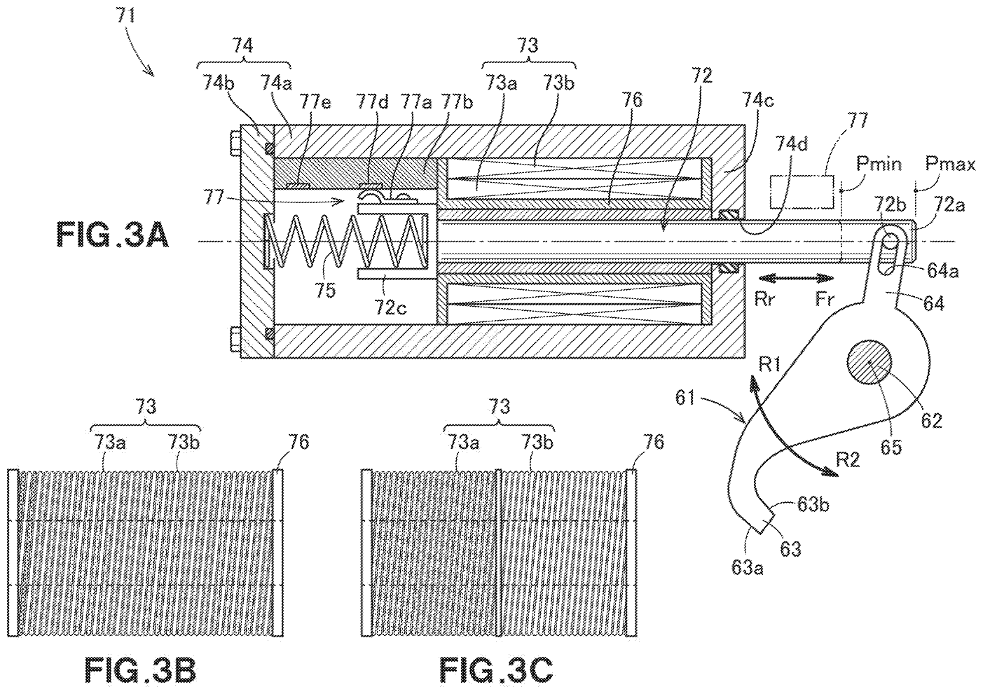

FIG. 3A illustrates a cross-sectional structure of the solenoid 71. As illustrated in FIG. 3A, the solenoid 71 is a pull-type solenoid that moves a plunger 72 backwardly by magnetization of a magnetizing coil 73. The plunger 72 and the magnetizing coil 73 are placed inside the housing 74. The housing 74 includes a main body 74a formed of, for example, a magnetic material in a cylindrical shape with a bottom, and a lid 74b formed of a magnetic material in a plate shape that closes the opening at the rear end of the main body 74a. A bottom plate 74c of the main body 74a has a through-hole 74d passing completely therethrough so as to allow the plunger 72 to move forwardly and backwardly.

The plunger 72 is a shaft formed of a magnetic material, and is supported so as to be movable forwardly and backwardly (i.e., slidable) relative to the housing 74. A tip portion 72a of the plunger 72 is extended from the through hole 74d to the exterior of the housing 74, and is coupled to the driven lever 64 of the swing lever 61. For example, the swing lever 61 is coupled to the plunger 72 by an engagement structure including a coupling pin 72b provided at the tip portion 72a of the plunger 72, and an elongated hole 64a (including a groove) provided in the tip of the driven lever 64.

The plunger 72 is always pushed by a pushing member 75 built in the housing 74 in a forward direction Fr (a direction Fr extended from the housing 74 to the exterior). This pushing member 75 is, for example, a compression coil spring located between the lid 74b and the rear end portion of the plunger 72. More specifically, the plunger 72 has a cylindrical spring catch portion 72c in the rear end portion. The spring catch portion 72c catches one end portion of the compression coil spring 75 (the pushing member 75). The pushing member 75 will be also referred to as a “second pushing member 75” as appropriate below.

The magnetizing coil 73 that drives the plunger 72 includes a first coil 73a and a second coil 73b, thus forming a tandem system. More specifically, the magnetizing coil 73 includes a cylindrical bobbin 76 with a flange in which the plunger 72 can be inserted, a first coil 73a wound around the bobbin 76, and a second coil 73b further wound around the outer circumference of the first coil 73a. As described above, the magnetizing coil 73 employs a double-winding structure by the first coil 73a and by the second coil 73b. The winding direction of the second coil 73b is consistent with the winding direction of the first coil 73a.

Note that the winding structure by the first coil 73a and by the second coil 73b is not limited to a double-winding structure illustrated in the above-described FIG. 3A, and for example, winding structures according to modified examples illustrated in FIG. 3B and FIG. 3C may be employed.

A first modified example illustrated in FIG. 3B is a so-called spiral-winding structure in which the first coil 73a and the second coil 73b are alternately wound turn by turn in the axial direction of the cylindrical bobbin 76 A second modified example illustrated in FIG. 3C is a so-called divisional-winding structure in which the first coil 73a is wound around a half of the bobbin 76 in the axial direction, and the second coil 73b is wound around the remaining half of the bobbin 76 in the axial direction.

A current is caused to flow through, for example, only either selected one of the first coil 73a or the second coil 73b. Note that the current may be caused to flow through both the first coil 73a and the second coil 73b. When magnetic fluxes flow through a magnetic circuit formed by magnetic-material components (the plunger 72 and the housing 74) surrounding the magnetizing coil 73, the plunger 72 is moved in a backward direction Rr (i.e., moved backwardly) by magnetic suction force.

Furthermore, the operative position restricting device 50 includes a position detecting unit 77. The position detecting unit 77 detects the slide position (the position in the lengthwise direction) of the plunger 72 relative to the housing 74. At least either one of a forward-movement position Pmax at which the tip of the plunger 72 is moved forward maximally relative to the housing 74 or a backward-movement position Pmin at which the tip of the plunger 72 is moved backward maximally is detectable by the position detecting unit 77. The position detecting unit 77 is, for example, built in the housing 74 or provided outside the housing 74 as indicated by an imaginary line in FIG. 3A.

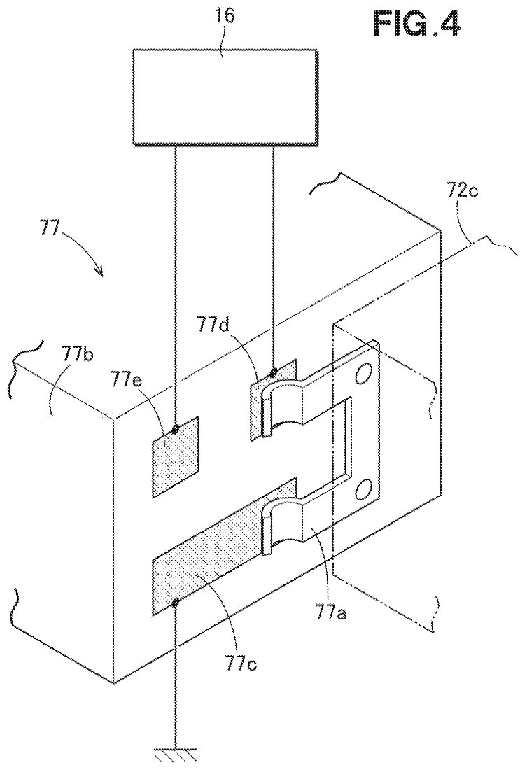

An example structure of the position detecting unit 77 will be described below. As illustrated in FIG. 3A and FIG. 4, the position detecting unit 77 employs a position-detecting-switch structure that includes a single slide contact 77a provided on the spring catch portion 72c of the plunger 72, and three stationary contacts 77c, 77d, and 77e provided on a substrate 77b. The slide contact 77a is a conductive plate formed in a fork-like shape with elasticity, and is movable together with the plunger 72. The substrate 77b is prevented from moving by the housing 74 and is held therein. The three stationary contacts 77c, 77d, and 77e include a first stationary contact 77c, a second stationary contact 77d and a third stationary contact 77e. The first stationary contact 77c is a common contact with which the slide contact 77a is always in contact, and is grounded.

The second stationary contact 77d can make an electrical-contact only when the plunger 72 is located at the forward-movement position Pmax. When the plunger 72 is located at the forward-movement position Pmax, the position detecting unit 77 transmits a maximum forward-movement position signal (a detection signal) to the control unit 16.

The third stationary contact 77e can make an electrical-contact only when the plunger 72 is located at the backward-movement position Pmin. When the plunger 72 is located at the backward-movement position Pmin, the position detecting unit 77 transmits a maximum backward-movement position signal (a detection signal) to the control unit 16.

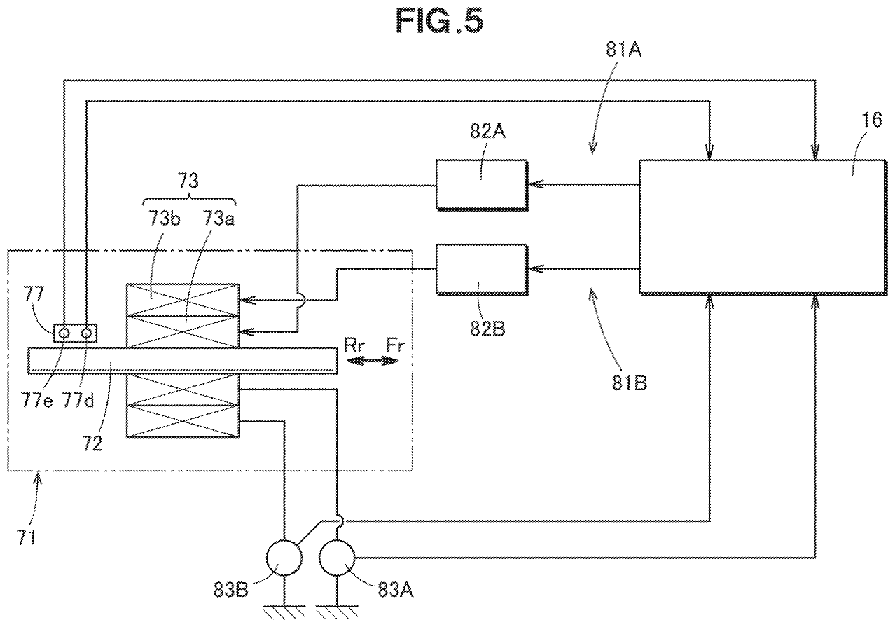

Next, a control structure for the solenoid 71 by the control unit 16 (see FIG. 1) will be described with reference to FIG. 5. The control unit 16 controls the magnetizing coil 73 through two control systems 81A and 81B. More specifically, the control unit 16 selects either one of the first coil 73a and the second coil 73b, and controls the first coil 73a or the second coil 73b in accordance with the selection.

The first control system 81A is an electric system that includes the control unit 16, a first solenoid drive circuit 82A, the first coil 73a, and a first current detector 83A. The first solenoid drive circuit 82A controls a drive current to be flown in the first coil 73a in accordance with a control signal from the control unit 16. The first current detector 83A detects the current flowing through the first coil 73a, and transmits a detection signal to the control unit 16.

The second control system 81B is an electric system that includes the control unit 16, a second solenoid drive circuit 82B, the second coil 73b, and a second current detector 83B. The second solenoid drive circuit 82B controls a drive current to be flown in the second coil 73b in accordance with the control signal from the control unit 16. The second current detector 83B detects the current flowing through the second coil 73b, and transmits the detection signal to the control unit 16.

As illustrated in FIG. 3A and FIG. 5, the control unit 16 magnetizes the first coil 73a (actuates the solenoid 71) by causing the first solenoid drive circuit 82A to flow the current in the first coil 73a. This causes the plunger 72 to move backwardly against the pushing force by the second pushing member 75, and to swing the swing lever 61 in the locking direction R2. Moreover, the control unit 16 un-magnetizes the first coil 73a (causes the solenoid 71 to be in an unactuated state) by terminating the drive current flowing in the first coil 73a from the first solenoid drive circuit 82A. This causes the plunger 72 to move forwardly by the pushing force by the second pushing member 75, and to swing the swing lever 61 in the unlocking direction R1. The sequential actions are the same as those of a case in which the second coil 73b is magnetized or un-magnetized.

Furthermore, the control unit 16 determines the states of the solenoid 71, first and second control systems 81A and 81B, and the state of the swing lever 61 based on the detection signal from the position detecting unit 77, and the detection signals from the first current detector 83A and from the second current detector 83B.

For example, in the following case (1) or (2), the control unit 16 determines that a malfunction occurs in the first control system 81A.

(1) When the control unit 16 transmits the control signal so as to magnetize the first coil 73a, a time until the plunger 72 reaches the backward-movement position Pmin from the forward-movement position Pmax is excessive.

(2) The current value detected by the first current detector 83A is excessively large or small.

In this case, the control unit 16 changes the system from the first control system 81A to the second control system 81B, and controls and drives the second coil 73b. The same is true of the case when the system is changed from the second coil 73b to the first coil 73a.

When a determination is made that a malfunction occurs at both of the first and second control systems 81A and 81B, both the first coil 73a and the second coil 73b are un-magnetized. Consequently, the solenoid 71 maintains the OFF state.

As illustrated in FIG. 1, the above-described control unit 16 receives respective detection signals from a steering angle sensor 91, a steering torque sensor 92, a motor rotation angle sensor 93, an output shaft rotation angle sensor 94, a turning shaft position sensor 95, a vehicle speed sensor 96, a yaw rate sensor 97, an acceleration sensor 98, and other various sensors 99, respectively, and transmits the control signals to the clutch 15, the reactive force motor 23, the turning power motor 41, and the solenoid 71.

The steering angle sensor 91 detects the steering angle of the steering wheel 11. The steering torque sensor 92 detects steering torque produced on the steering shaft 21. The steering torque sensor 92 may be placed at the steering-wheel-11 side relative to the reactive force transmission mechanism 24 in the steering shaft 21. Such a placement enables the steering torque sensor 92 to detect the steering torque (steering load). The motor rotation angle sensor 93 detects the rotation angle of the reactive force motor 23. The output shaft rotation angle sensor 94 detects the rotation angle of the output shaft 34 that has the pinion 35a. The turning shaft position sensor 95 detects the moved position of the turning shaft 36 that has the rack 35b. The vehicle speed sensor 96 detects the wheel speed of the vehicle. The yaw rate sensor 97 detects a yaw angular speed (angular speed of yaw moment) of the vehicle. The acceleration sensor 98 detects the acceleration of the vehicle. The other various sensors 99 include a rotation angle sensor that detects the rotation angle of the turning power motor 41. The rotation angle sensor is, for example, a resolver provided on the turning power motor 41.

Next, an action of the operative position restricting device 50 that employs the above-described structure will be described with reference to FIG. 1 and FIG. 2. In this case, a driver's operation to turn the steering wheel 11 in a direction in which the steering angle increases will be referred to as a “turn increasing operation”. A driver's operation to turn the steering wheel 11 in a direction in which the steering angle decreases (a neutral direction) after the turn increasing operation will be referred to as a “turn returning operation”.

As illustrated in FIG. 2, the plunger 72 of the solenoid 71 is now maintained in a state moved forwardly (extended state). Hence, the stopper part 63 of the swing lever 61 is disengaged from the tooth groove 53 of the locking wheel 51.

Subsequently, when the steering wheel 11 is turned to the right side, i.e., the turn increasing operation is given, the locking wheel 51 rotates in a clockwise direction R3 (a right direction R3). When the turn increasing operation is given to the steering wheel 11 up to the limit of the turnable range, the control unit 16 determines that it reaches the limit based on the detection value by the steering angle sensor 91, and magnetizes the magnetizing coil 73 (see FIG. 3) of the solenoid 71. When magnetized, the magnetizing coil 73 moves the plunger 72 backwardly, and maintains the state moved backwardly. That is, the solenoid 71 becomes an ON (turn on) state. Consequently, the swing lever 61 swings so as to cause the stopper part 63 to enter the tooth groove 53 of the locking wheel 51.

When the locking wheel 51 further rotates in the clockwise direction R3, a first tooth surface 52a of the tooth 52 contacts the latching surface 63a of the stopper part 63. Consequently, the locking wheel 51 has the rotation in the clockwise direction R3 restricted by the swing lever 61.

Accordingly, when the turn increasing operation is given to the steering wheel 11 up to the limit of the turnable range, the turning shaft 36 can be restricted before moving to the movable limit (a rack end) in the axial direction. Hence, the turning shaft 36 is prevented from contacting the stopper for movement restriction. The shaft end part of the turning shaft 36 is protected, while at the same time, a production of hitting sounds can be prevented.

Subsequently, when the operation of turning the steering wheel 11 to the left side, i.e., the turn returning operation starts, the control unit 16 determines that, based on the detection value by the steering angle sensor 91, the turn returning operation starts, and causes the magnetizing coil 73 (see FIG. 3) of the solenoid 71 to be un-magnetized. This causes the solenoid 71 to be in an unactuated state. Since the magnetizing coil 73 becomes un-magnetized, the plunger 72 moves forward in accordance with the pushing force by the pushing member 75 (see FIG. 3), and maintains the state moved forwardly. Accordingly, the swing lever 61 swings in such a way that the stopper part 63 is disengaged with the tooth groove 53 of the locking wheel 51. Since the rotation of the locking wheel 51 is now allowed, the turn returning operation to the steering wheel 11 is also allowed.

The above-described action is also the same as that of a case in which the locking wheel 51 rotates in the counterclockwise direction R4 (the left direction R4) when the steering the steering wheel 11 is turned to the left side, i.e., the turn increasing operation is given.

The description for the first embodiment can be summarized as follows.

As illustrated in FIG. 2 and FIGS. 3A to 3C, the stopper device 50 for vehicle according to the first embodiment includes:

the movable member 51;

the swing lever 61 capable of swinging in the direction in which the movable member 51 is locked;

the solenoid 71 that includes the plunger 72 coupled to the swing lever 61, and the magnetizing coil 73 to drive the plunger 72; and

the pushing member 66 (the first pushing member 66) that pushes the swing lever 61 in the unlocking direction R1 relative to the movable member 51.

As described above, the swing lever 61 capable of swinging in the direction R2 in which the movable member 51 is locked is coupled to the plunger 72 of the solenoid 71. Moreover, the swing lever 61 is pushed by the pushing member 66 in the unlocking direction R1. Accordingly, when the magnetizing coil 73 is not magnetized, even if the swing lever 61 is still in the locked state relative to the movable member 51 due to any causes, the first pushing member 66 surely causes the swing lever 61 to swing in the unlocking direction R1.

For example, it is assumed that a malfunction occurs in both the first coil 73a and the second coil 73b, or an open-circuit malfunction/short-circuit malfunction occurs in both the first control system 81A, and the second control system 81B, and thus the magnetizing coil 73 becomes an un-magnetized state. In this case, the first pushing member 66 can surely cause the swing lever 61 to swing in the unlocking direction R1.

This enables the movable member 51 to surely and promptly return to the unlocked state. That is, when the magnetizing coil 73 is in an un-magnetized state, the movable member 51 can be in an original movable state. As described above, the stopper device 10 for vehicle can be provided which is capable of maintaining an appropriate operation as much as possible under any situation when the magnetizing coil 73 is in an un-magnetized state.

As illustrated in FIG. 5, the magnetizing coil 73 includes the first coil 73a and the second coil 73b that form a tandem system. Hence, even if a malfunction occurs in either one of the first coil 73a or the second coil 73b or an open-circuit malfunction/short-circuit malfunction occurs in either one of the first control system 81A or the second control system 81B, by changing the coil or the control system to the other, a compensation can be achieved (i.e., a redundancy can be achieved). Consequently, the driving control on the solenoid 71 can be maintained.

As illustrated in FIG. 3A and FIG. 4, the above-described stopper device 50 for vehicle includes the position detecting unit 77 that detects the slide position (the position in the lengthwise direction) of the plunger 72. Hence, the position detecting unit 77 can detect at least either the forward-movement position Pmax of the plunger 72 or the backward-movement position Pmin. Moreover, by monitoring a time at which the plunger 72 slides between the forward-movement position Pmax and the backward-movement position Pmin, the state of the solenoid 71, and the position of the swing lever 61 cam be surely monitored.

As illustrated in FIG. 3A and FIG. 5, the solenoid 71 is a pull-type solenoid that moves the plunger 72 backwardly by magnetization of the magnetizing coil 73. Accordingly, when the magnetizing coil 73 is in an un-magnetized state, the plunger 72 can be forcibly extended by the pushing force from the second pushing member 75. Accordingly, when the magnetizing coil 73 becomes malfunction or an open-circuit malfunction/short-circuit malfunction occurs in the solenoid drive circuits 82A and 82B or the control circuit, the plunger 72 can be surely extended. Consequently, the movable member 51 can be in an original movable state.

As described above, the stopper device 50 for vehicle includes the two pushing members that are the first pushing member 66 and the second pushing member 75. Hence, even if a malfunction occurs in either one of the two pushing members 66 and 75, the other can compensate (i.e., a redundancy can be achieved). Even a malfunction occurs in the magnetizing coil 73 or in an electric system, the movable member 51 can be in an original movable state by at least either one of the two pushing members 66 and 75.

As illustrated in FIG. 1 and FIG. 2, the stopper device 50 for vehicle is built in a so-called steer-by-wire steering device 10 for vehicle that has the steering unit 12 at which a turning operation of the steering wheel 11 is input and the turning unit 14 that turns the turning wheels 13 and 13, those units being mechanically separated from each other. The movable member 51 is rotatable together with the steering wheel 11. The swing lever 61 is a component capable of restricting the rotational range of the movable member 51 by being latched with the movable member 51.

Hence, while the driver is giving the turn increasing operation on the steering wheel 11, when the swing lever 61 (the latching member 61) is latched with the movable member 51 (the latched member 51), and immediately after this operation, the driver gives the turn returning operation to the steering wheel 11, the stopper device 50 for vehicle forcibly cancels the latched state of the swing lever 61 to the movable member 51. Accordingly, the operation from the turn increasing operation to the turn returning operation can be promptly and smoothly transitioned. This enhances the controllability of the steering device 10 for vehicle.

### Second Embodiment

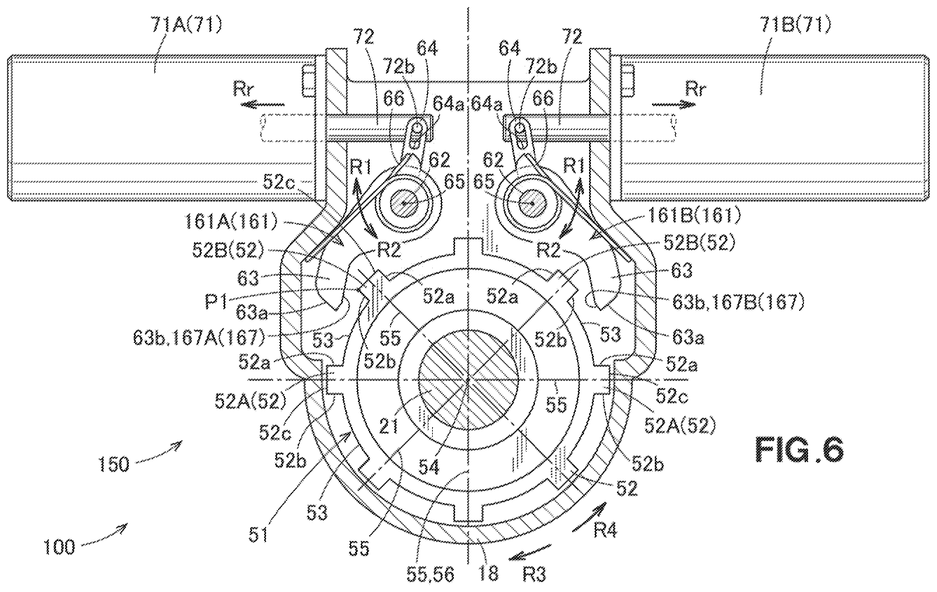

A steering device 100 for vehicle according to a second embodiment will be described with reference to FIG. 6. The steering device 100 for vehicle according to the second embodiment has a feature such that the stopper device 50 for vehicle of the steering device 10 for vehicle according to the above-described first embodiment as illustrated in FIG. 1 or FIG. 5 is changed to a stopper device 150 for vehicle, and the other structural components are the same as those of the first embodiment. Hence, the same reference numerals are given thereto and the detailed description thereof will be omitted.

The stopper device 150 for vehicle (the operative position restricting device 150) according to the second embodiment includes the single movable member 51 (the latched member 51 and the locking wheel 51), two swing levers 161 and 161 (latching members 161 and 161) corresponding to the single movable member 51, the two pushing members 66 and 66, and the two solenoids 71 and 71. The movable member 51, the swing levers 161 and 161, the pushing members 66 and 66, and the solenoids 71 and 71 are placed inside the housing 18.

The structure of the movable member 51 is the same as that of the first embodiment.

The structure of each swing lever 161 and 161 is basically the same structure as that of the swing lever 61 according to the first embodiment. A feature of each swing lever 161 and 161 is that each second latching surface 63b and 63b is inclined relative to each first latching surface 63a and 63a. Hence, the contour of each stopper part 63 and 63 as viewed from the axial direction of the steering shaft 21 is a tapered shape that becomes narrow toward the tip.

The one swing lever 161 in the two swing levers 161 and 161 will be defined as the “first swing lever 161A”, and the other swing lever 161 will be defined as the “second swing lever 161B”. When the steering wheel 11 illustrated in FIG. 1 is turned to one side (the steering direction to the right side), the first swing lever 161A can be latched with the locking wheel 51. When the steering wheel 11 is turned to another side (the steering direction to the left side), the second swing lever B can be latched with the locking wheel 51.

With the steering shaft 21 being viewed from the axial direction, the second swing lever 161B is placed in reverse relative to the first swing lever 161A. For example, the first swing lever 161A and the second swing lever 161B employ the same structure except that those are symmetrical to each other relative to the straight line 56 intersecting with the center axis 54 of the steering shaft 21.

Next, a relationship between the locking wheel 51 and the first swing lever 161A will be described. In the following description, in order to facilitate understanding to the description, with the stopper part 63 being entering the tooth groove 53, a tooth 52A that faces the first latching surface 63a among the plurality of teeth 52 will be referred to as a “first tooth 52A”, and a tooth 52B that faces the second latching surface 63b will be referred to as a “second tooth 52B”.

With the stopper part 63 of the first swing lever 161A being entering the tooth groove 53 of the locking wheel 51, the first latching surface 63a faces the tooth surface 52a (the first tooth surface 52a) of the first tooth 52A. When the locking wheel 51 rotates in the clockwise direction R3, the first tooth surface 52a of the first tooth 52A contacts the first latching surface 63a of the stopper part 63.

The second latching surface 63b of the stopper part 63 is an inclined surface (a slope) that faces, while inclining, the other tooth surface 52b (the second tooth surface 52b) of the second tooth 52B of the locking wheel 51. The second latching surface 63b will be also referred to as the “inclined surface 63b” as appropriate below.

With the stopper part 63 of the first swing lever 161A being entering the tooth groove 53 of the locking wheel 51, when the locking wheel 51 rotates in the counterclockwise direction R4, a corner edge P1 between a tip of the second tooth surface 52b of the second tooth 52B and a tooth-tip surface 52c contacts the inclined surface 63b of the stopper part 63.

By the force that the corner edge P1 contacts the inclined surface 63b, the stopper part 63 is enabled to swing in the direction R1 unlatched from the second tooth 52B. That is, the inclined surface 63b converts the rotational force of the locking wheel 51 into force that cancels the latched state of the first swing lever 161A. As described above, the inclined surface 63b includes a forcible canceling mechanism 167 that forcibly cancels the latched state of the first swing lever 161A relative to the locking wheel 51.

The structure of the two pushing members 66 and 66 is the same as that of first embodiment, and those members push the respective swing levers 161A and 161B in the unlocking direction R1 relative to the movable member 51.

The structure of the two solenoids 71 and 71 is the same as that of the first embodiment, and those solenoids are attached to the housing 18. The one solenoid 71 in the two solenoids 71 and 71 will be defined as the “first solenoid 71A”, and the other solenoid 71 will be defined as the “second solenoid 71B”. The plunger 72 of the first solenoid 71A is coupled to the driven lever 64 of the first swing lever 161A. The plunger 72 of the second solenoid 71B is coupled to the driven lever 64 of the second swing lever 161B.

Next, an action of the stopper device 150 for vehicle according to the second embodiment will be described. Presently, as illustrated in FIG. 6, the respective plungers 72 and 72 of the solenoids 71A and 71B are maintained in a state moved forwardly (the extended state). Hence, the stopper parts 63 and 63 of the respective swing levers 161A and 161B are unlatched from the tooth grooves 53 of the locking wheel 51.

Subsequently, when the steering wheel 11 is turned to the right side, i.e., the turn increasing operation is given thereto, the locking wheel 51 rotates in the clockwise direction R3. When the turn increasing operation is given to the steering wheel 11 up to the limit of the turnable range, the control unit 16 actuates (turns ON) the first solenoid 71A only. The first solenoid 71A moves the plunger 72 backwardly, and maintains the state moved backwardly. This causes the first swing lever 161A to swing in such a way that the stopper part 63 enters the tooth groove 53 of the locking wheel 51.

When the locking wheel 51 further rotates in the clockwise direction R3, the first tooth surface 52a of the first tooth 52A contacts the first latching surface 63a of the stopper part 63. Consequently, the locking wheel 51 has the rotation in the clockwise direction R3 restricted by the first swing lever 161A.

Subsequently, when the steering wheel 11 is turned to the left side, i.e., the turn returning operation starts, the control unit 16 causes the first solenoid 71A to be in an unactuated state. The first solenoid 71A moves the plunger 72 forwardly, and maintains the state moved forwardly. Hence, the first swing lever 161A swings in such a way that the stopper part 63 is unlatched from the tooth groove 53 of the locking wheel 51. Since the rotation of the locking wheel 51 is now allowed, the turn returning operation to the steering wheel 11 is also allowed.

Conversely, with the stopper part 63 of the first swing lever 161A being entering the tooth groove 53 of the locking wheel 51, the driver may give the turn increasing operation to the steering wheel 11, and may start the turn returning operation before reaching the limit of the turnable range.

In this case, the stopper part 63 of the first swing lever 161A is not completely unlatched from the tooth groove 53 of the locking wheel 51. In accordance with the driver's turn returning operation, the locking wheel 51 rotates in the counterclockwise direction R4. The corner edge P1 of the second tooth 52B contacts the second latching surface 63b of the first swing lever 161A, causing the stopper part 63 to swing in the direction R1 unlatched from the second tooth 52B.

The swing operation of the first swing lever 161A causes the plunger 72 of the first solenoid 71A to move forward. In this case, the magnetizing coil 73 (see to FIG. 3) of the first solenoid 71A is in the magnetized state. However, the force of the swing operation by the first swing lever 161A forcibly moves the plunger 72 forwardly. Consequently, since the rotation of the locking wheel 51 is allowed, the turn returning operation to the steering wheel 11 is also allowed. As described above, the operation can be promptly transitioned from the turn increasing operation to the turn returning operation.

The description for the relationship between the locking wheel 51 and the second swing lever 161B will be omitted. As is clear from the above description, the inclined surface 63b of the second swing lever 161B is in reverse relative to the inclined surface 63a of the first swing lever 161A. The first swing lever 161A and the second swing lever 161B include the respective forcible canceling mechanisms 167 and 167 (the inclined surfaces 63b and 63b). That is, the forcible canceling mechanisms 167 are two which are a first forcible canceling mechanism 167A of the first swing lever 161A, and a second forcible canceling mechanism 167B of the second swing lever 161B.

The description on the second embodiment will be summarized as follows. For example, it is assumed that the driver keenly changes the operation to the steering wheel 11 from the turn increasing operation to the turn returning operation. That is, this is a case in which, while the driver is giving the turn increasing operation to the steering wheel 11, the swing levers 161A and 161B are latched with the movable member 51, and then the driver quickly gives the turn returning operation to the steering wheel 11. In this case, the forcible canceling mechanisms 167A and 167B forcibly cancel the latched states of the swing levers 161A and 161B with the movable member 51. Hence, the operation can be promptly and smoothly transitioned from the turn increasing operation to the turn returning operation. This enhances the controllability of the steering device 100 for vehicle. Moreover, since there is the single movable member 51 for the two swing levers 161A and 161B, the number of components can be small.

Furthermore, the forcible canceling mechanisms 167A and 167B are the inclined surfaces 63b and 63b. Hence, the forcible canceling mechanisms 167A and 167B can be a simple structure.

The other actions and advantageous effects of the second embodiment are the same as those of the above-described first embodiment.

### Third Embodiment

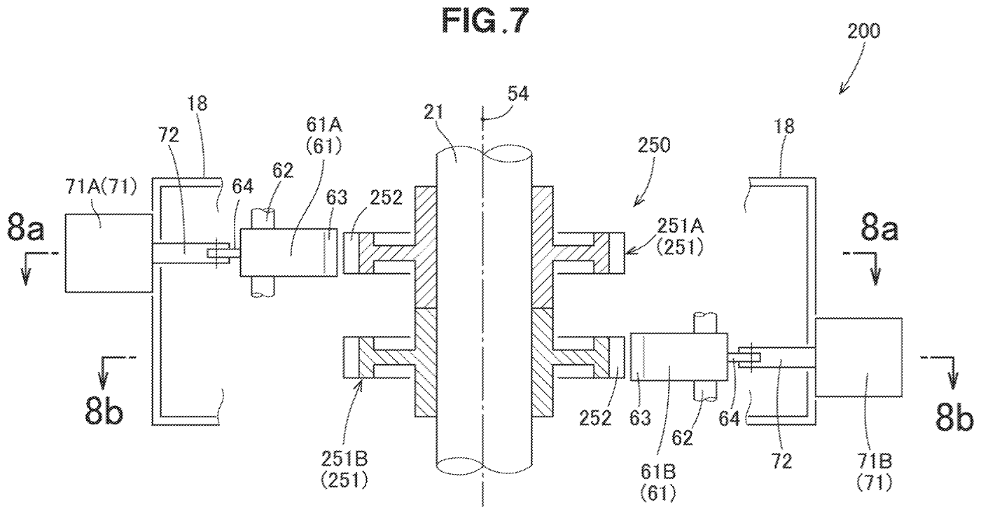

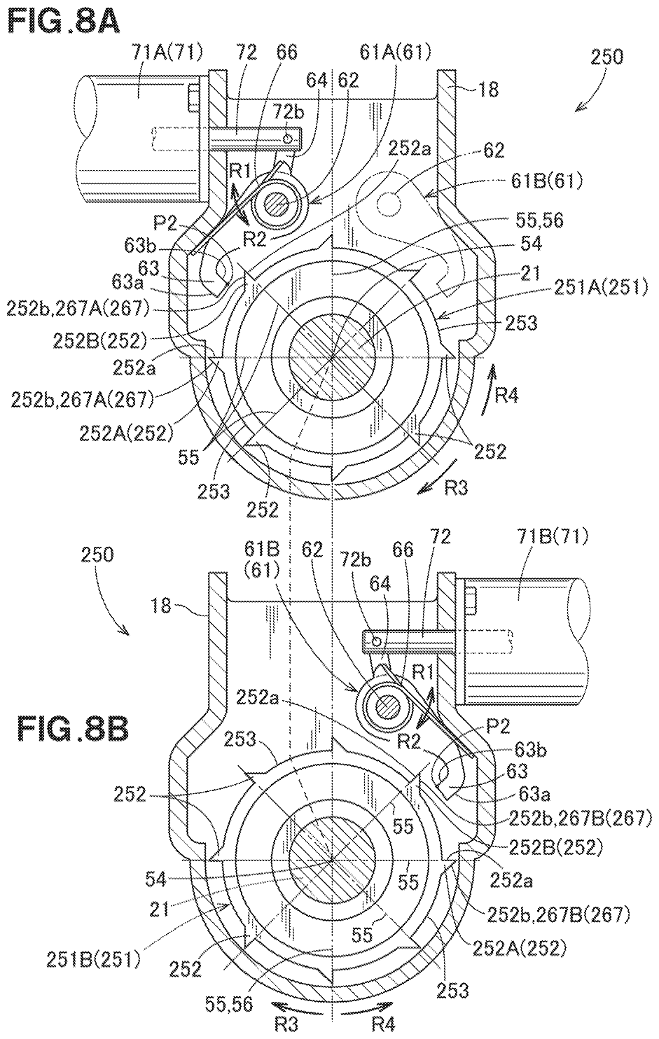

A steering device 200 for vehicle according to a third embodiment will be described with reference to FIG. 7 and FIGS. 8A and 8B. The steering device 200 for vehicle according to the third embodiment has a feature such that the stopper device 150 (the operative position restricting device 150) for vehicle of the steering device 100 for vehicle according to the above-described second embodiment illustrated in FIG. 6 is changed to a stopper device 250 (an operative position restricting device 250) for vehicle illustrated in FIG. 7 and FIGS. 8A and 8B. Since the other structural components are the same as those of second embodiment, the same reference numerals will be given thereto and the detailed description thereof will be omitted.

The stopper device 250 for vehicle has a feature that is the following three changes. The first change is that the single movable member 51 according to the second embodiment is changed to two movable members 251 and 251 (latched members 251 and 251). The second change is that the two swing levers 161 and 161 according to the second embodiment are changed to the two swing levers 61 and 61 (the latching members 61 and 61) having the same structure as that of the first embodiment. The third change is that the two forcible canceling mechanisms 167 and 167 according to the second embodiment are changed to two (dual) forcible canceling mechanisms 267 and 267.

The stopper device 250 for vehicle will be described in detail below. FIG. 7 illustrates the stopper device 250 for vehicle according to the third embodiment. FIG. 8A illustrates a cross-section taken along an arrow line 8a-8a in FIG. 7. FIG. 8 B illustrates a cross-section taken along an arrow line 8b-8b in FIG. 7.

The stopper device 250 for vehicle includes the two movable members 251 and 251, the two swing levers 61 and 61, and the dual forcible canceling mechanisms 267 and 267. The movable members 251 and 251, the swing levers 61 and 61, and the forcible canceling mechanisms 267 are 267 are placed inside the housing 18.

The two movable members 251 and 251 are each in a disk shape rotatable together with the steering wheel 11, and attached to, for example, the steering shaft 21. The two movable members 251 and 251 are arranged in the axial direction of the steering shaft 21, the one movable member will be defined as a first movable member 251A (a first latched member 251A), while the other movable member will be defined as a second movable member 251B (a second latched member 251B).

The movable members 251A and 251B are each a locking wheel (locking gear) having a plurality of teeth 252 arranged at a certain pitch in the rotational direction. The plurality of teeth 252 are arranged in the outer circumference surface of each movable member 251A and 251B or the disk-edge surface thereof. The first movable member 251A will be also referred to as a “first locking wheel 251A” as appropriate, and the second movable member 251B will be also referred to as a “second locking wheel 251B” as appropriate below.

The locking wheels 251A and 251B have a feature such that, with respect to the locking wheel 51 according to the second embodiment illustrated in FIG. 6, the shapes of the plurality of teeth 152 are changed, and the other structures are the same as those of the second embodiment. That is, the shapes of the plurality of teeth 52 of the locking wheel 51 according to the second embodiment are each a rectangular shape. In contrast, according to the third embodiment, when each locking wheel 251A and 251B is viewed along the rotational center line 54, the shapes of the plurality of teeth 252 are each a tapered triangular shape with a keen tip, and are asymmetrical at the right and left sides relative to each straight line 55 which intersects the rotational center line 54 and which extends in the radial direction.

More specifically, the plurality of teeth 252 of the first locking wheel 251A each has one tooth surface 252a (a first tooth surface 252a) and the other tooth surface 252b (a second tooth surface 252b). The first tooth surface 252a is a tooth surface which becomes a front side when the first locking wheel 251A rotates in the clockwise direction R3.

When the first locking wheel 251A is viewed along the rotational center line 54, each first tooth surface 252a is a flat straight surface along, for example, each straight line 56. The thickness of the tooth 252 increases from the tooth tip to the tooth bottom. The second tooth surface 252b is a tooth surface at the opposite side to the first tooth surface 252a, and is an inclined surface (a slope) inclined from the tooth tip of the tooth 252 to the tooth bottom thereof. The second tooth surface 252b will be also referred to as an “inclined surface 252b” as appropriate below.

As illustrated in FIG. 8A and FIG. 8B, the direction of the plurality of teeth 252 of the second locking wheel 251B is in reverse relative to the direction of the plurality of teeth 252 of the first locking wheel 251A.

The structure of each swing lever 61 and 61 is the same structure as that of the swing lever 61 according to the first embodiment. The one in the two swing levers 61 and 61 which is to be latched with the first locking wheel 251A will be defined as a “first swing lever 61A”, and the other to be latched with the second locking wheel 251B will be defined as a “second swing lever 61B”. Each swing lever 61A and 61B is individually latched with each locking wheel 251A and 251B, thereby restricting the rotational range of each locking wheel 251A and 251B.

As illustrated in FIG. 8A and FIG. 8B, with the steering shaft 21 being viewed from the axial direction, the second swing lever 61B is arranged in reverse relative to the first swing lever 61A. For example, the first swing lever 61A and the second swing lever 61B are symmetrical to each other relative to the straight line 56 which intersects the center axis 54 of the steering shaft 21, but other structures are the same.

Next, the relationship between the first locking wheel 251A and the first swing lever 61A will be described in detail. Note that the relationship between the second locking wheel 251B and the second swing lever 61B is the same except that it is in reverse relative to the relationship between the first locking wheel 251A and the first swing lever 61A, and thus the detailed description thereof will be omitted.

When the steering wheel 11 illustrated in FIG. 1 is turned to the right side, the first locking wheel 251A rotates in the clockwise direction R3.

In order to facilitate understanding to the description, with the stopper part 63 being entering a tooth groove 253 of the first locking wheel 251A, a tooth 252A that faces the first latching surface 63a among the plurality of teeth 252 will be referred to as a “first tooth 252A”, and a tooth 252B that faces the second latching surface 163b will be referred to as a “second tooth 252B”.

With the stopper part 63 of the first swing lever 61A being entering the tooth groove 253 of the first locking wheel 251A, the first latching surface 63a faces the one tooth surface 252a (the first tooth surface 252a) of the first tooth 252A. When the first locking wheel 251A rotates in the clockwise direction R3, the first tooth surface 252a of the first tooth 252A contacts the first latching surface 63a of the stopper part 63. Consequently, the first locking wheel 251A has the rotation in the clockwise direction R3 restricted by the first swing lever 61A.

When the steering wheel 11 is turned to the left side, the first locking wheel 251A rotates in the counterclockwise direction R4.

With the stopper part 63 of the first swing lever 61A being entering the tooth groove 253 of the first locking wheel 251A, when the first locking wheel 251A rotates in the counterclockwise direction R4, the second tooth surface 252b (the inclined surface 252b) of the second tooth 252B contacts a corner edge P2 of the second latching surface 63b of the stopper part 63. The corner edge P2 with which the inclined surface 252b contacts will be referred to as an “abutment point P2”.

The force produced by the inclined surface 252b (the second tooth surface 252b) contacting the abutment point P2 enables the stopper part 63 to swing in the direction R1 unlatched from the second tooth 252B. That is, the inclined surface 252b converts the rotational force by the first locking wheel 251A into force of canceling the latched state of the first swing lever 61A. As described above, the inclined surface 252b includes the forcible canceling mechanism 267 capable of forcibly canceling the latched state of the first swing lever 61A to the first locking wheel 251A.

Next, an action of the stopper device 250 for vehicle according to the third embodiment will be described. Presently, the plungers 72 and 72 of the respective solenoids 71A and 71B are maintained in the state moved forwardly (extended state). Hence, the stopper parts 63 and 63 of the respective swing levers 61A and 61B are unlatched from the tooth grooves 253 and 253 of the locking wheels 251A and 251B, respectively.

Subsequently, when the steering wheel 11 is turned to the right side, i.e., the turn increasing operation is given, the locking wheels 251A and 251B are (rotate) in the clockwise direction R3. When the turn increasing operation to the steering wheel 11 is given up to the limit of the turnable range, the control unit 16 (see FIG. 1) causes a current to flow through the first solenoid 71A only to move the plunger 72 backwardly. The first solenoid 71A moves the plunger 72 backwardly, and maintains the backward-movement state. Consequently, the first swing lever 61A swings in such a way that the stopper part 63 enters the tooth groove 253 of the first locking wheel 251A.

When the first locking wheel 251A further rotates in the clockwise direction R3, the first tooth surface 252a of the first tooth 252A contacts the first latching surface 63a of the stopper part 63. Consequently, the first locking wheel 251A has the rotation in the clockwise direction R3 restricted by the first swing lever 61A.

Subsequently, when the steering wheel 11 is turned to the left side, i.e., the turn returning operation starts, the control unit 16 un-actuates the first solenoid 71A. The first solenoid 71A moves the plunger 72 forwardly, and maintains the forward-movement state. Hence, the first swing lever 61A swings in such a way that the stopper part 63 is unlatched from the tooth groove 253 of the first locking wheel 251A. Since the rotation of the first locking wheel 251A is allowed, the turn returning operation to the steering wheel 11 is also allowed.

Conversely, with the stopper part 63 of the first swing lever 61A being entering the tooth groove 253 of the first locking wheel 251A, the driver may give the turn increasing operation to the steering wheel 11, and start the turn returning operation before reaching the limit of the turnable range.

In this case, the stopper part 63 of the first swing lever 61A is not completely unlatched from the tooth groove 253 of the first locking wheel 251A. In accordance with the driver's turn returning operation, the first locking wheel 251A rotates in the counterclockwise direction R4. Consequently, when the abutment point P2 contacts the second latching surface 63b of the first swing lever 61A, the stopper part 63 swings in the direction R1 unlatched from the second tooth 252B.

As is clear from the above description, the first locking wheel 251A and the second locking wheel 251B include the respective forcible canceling mechanisms 267 and 267 (the inclined surfaces 252b and 152b). That is, the forcible canceling mechanism 267 is two set (dual) including a plurality of first forcible canceling mechanisms 267A of the first locking wheel 251A, and a plurality of second forcible canceling mechanisms 267B of the second locking wheel 251B.

The description on the third embodiment will be summarized as follows. It is assumed that the driver keenly changes the operation from the turn increasing operation to the steering wheel 11 to the turn returning operation. In this case, the forcible canceling mechanisms 267A and 267B forcibly cancel the latched state of the swing levers 61A and 61B relative to the respective movable members 251A and 251B. Hence, the operation can be promptly and smoothly transitioned from the turn increasing operation to the turn returning operation. This enhances the controllability of the steering device 200 for vehicle.

Moreover, the two sets each including the locking wheel 251, the swing lever 61, and the forcible canceling mechanism 267 are provided, and the position of each set can be offset. For example, the positions of the second swing lever 61B and of the second forcible canceling mechanisms 267B can be offset relative to the positions of the first swing lever 61A and of the first forcible canceling mechanisms 267A. Hence, the degree of freedom for placement of each member can be improved.

Furthermore, the forcible canceling mechanisms 267A and 267B are each formed by the inclined surface 252b. Hence, the forcible canceling mechanisms 267A and 267B can each employ a simple structure by the inclined surface 252b.

The other actions and advantageous effects according to the third embodiment are the same as those of the second embodiment.

Note that the steering devices 10, 100 and 200 for vehicle according to the present disclosure are not limited to the embodiments as long as the actions and advantageous effects of the present disclosure are achievable. For example, a structure of a steer-by-wire type vehicular steering device that has the steering unit 12 and the turning unit 14 mechanically and completely separated from each other may be adopted by eliminating the clutch 15, the shaft universal joints 31 and 31, the coupling shaft 32, the input shaft 33, the output shaft 34, and the operative force transmission mechanism 35 illustrated in FIG. 1.

Moreover, the inclined surfaces 63b and 252b are not limited to an inclined flat surface but may be, for example, a circular-arc surface.

Furthermore, the position detecting unit 77 is not limited to a structural component that is the position detecting switch, and may be, for example, a structural component that is a variable resistor.

### INDUSTRIAL APPLICABILITY

The steering devices 10, 100 and 200 for vehicle according to the present disclosure are suitably built in a vehicle.

### REFERENCE SIGNS LIST

10 Steering device for vehicle (first embodiment)
11 Steering wheel
12 Steering unit
13 Turning wheel
14 Turning unit
50 Stopper device for vehicle
51 Movable member
61 Swing lever
61A First swing lever
61B Second swing lever
66 Pushing member
71 Solenoid
72 Plunger
73 Magnetizing coil
73a First coil
73b Second coil
77 Position detecting unit
100 Steering device for vehicle (second embodiment)
150 Stopper device for vehicle
161 Swing lever
161A First swing lever
161B Second swing lever
167 Forcible canceling mechanism
167A First forcible canceling mechanism
167B Second forcible canceling mechanism
200 Steering device for vehicle (third embodiment)
250 Stopper device for vehicle
251 Movable member
251A First movable member
251B Second movable member
267 Forcible canceling mechanism
267A First forcible canceling mechanism
267B Second forcible canceling mechanism
R1 Unlocking direction

1. A stopper device for vehicle comprising:
a movable member rotatable together with a steering wheel;
a swing lever capable of swinging in a direction in which the movable member is locked;
a solenoid that comprises a plunger coupled to the swing lever and a magnetizing coil to drive the plunger, and that moves the plunger backwardly by magnetization of the magnetizing coil to cause the swing lever to swing in the locking direction;
a first pushing member that pushes the swing lever in n unlocking direction relative to the movable member; and
a second pushing member that pushes the plunger n a forward-movement direction,
wherein, with the magnetizing coil not being magnetized, when either one of the first pushing member or the second pushing member becomes malfunction, the wring lever is capable of swinging in the unlocking direction.

2. The stopper device for vehicle according claim 1, wherein the magnetizing coil comprises a first coil and a second coil that form a tandem system.

3. The stopper device for vehicle according to claim 1, further comprising a position detecting unit that detects a slide position of the plunger.

4. The stopper device for vehicle according to claim 1, wherein the solenoid is a pull-type solenoid that moves the plunger backwardly by magnetization of the magnetizing coil.

5. The stopper device for vehicle according to claim 1, wherein said stopper device is built in a steering device for vehicle that has a steering unit at which a turning operation of the steering wheel is input and a turning unit that turns turning wheels, the steering unit and the turning unit being mechanically separated from each other,
wherein the swing lever is a component capable of restricting a rotational range of the movable member by being latched with the movable member.

6. The stopper device for vehicle according to claim 2, further comprising a position detecting unit that detects a slide position of the plunger.

7. The stopper device for vehicle according to claim 2, wherein the solenoid is a pull-type solenoid that moves the plunger backwardly by magnetization of the magnetizing coil.

8. The stopper device for vehicle according to claim 2, wherein said stopper device is built in a steering device for vehicle that has a steering unit at which a turning operation of the steering wheel is input and a turning unit that turns turning wheels, the steering unit and the turning unit being mechanically separated from each other,
wherein the swing lever is a component capable of restricting a rotational range of the movable member by being latched with the movable member.

9. The stopper device for vehicle according to claim 3, wherein the solenoid is a pull-type solenoid that moves the plunger backwardly by magnetization of the magnetizing coil.

10. The stopper device for vehicle according to claim 3, wherein said stopper device is built in a steering device for vehicle that has a steering unit at which a turning operation of the steering wheel is input and a turning unit that turns turning wheels, the steering unit and the turning unit being mechanically separated from each other,
wherein the swing lever is a component capable of restricting a rotational range of the movable member by being latched with the movable member.

11. The stopper device for vehicle according to claim 4, wherein said stopper device is built in a steering device for vehicle that has a steering unit at which a turning operation of the steering wheel is input and a turning unit that turns turning wheels, the steering unit and the turning unit being mechanically separated from each other,
wherein the swing lever is a component capable of restricting a rotational range of the movable member by being latched with the movable member.
